(19) United States
(12) Patent Application Publication
(10) Pub. No.: US 2006/0039538 A1
(43) Pub. Date: Feb. 23, 2006

(54) "Software only" tool for testing networks under high-capacity, real-world conditions

(76) Inventors: John Allen Minnis, McKinney, TX (US); Kevin Earl Canady, Garland, TX (US)

Correspondence Address: Edward G. Durney, Patent Strategies, 11 Rosalita Lane, Millbrae, CA, 94030, US

(21) Appl. No.: 10/924,156

(22) Filed: Aug. 23, 2004

(51) Int. Cl. H04M 1/24; H04B 17/00

(52) U.S. Cl. 379/1.01; 455/67.11; 455/67.14

(57) ABSTRACT

A high-performance software tool for testing networks, having many new features. First, the test tool combines both control traffic and data traffic generation in one platform. Existing tools do only one or the other. Second, by dynamically linking protocol stacks, the test tool achieves stunning performance levels. More than 1,000 new sessions per second per test server. More than 200,000 simultaneous sessions per test server. Modeling real-world traffic requires these speeds. Third, even at these speeds, each session simulates real-world user activities with “stateful,” meaningful data. Fourth, the test tool has a “software only” architecture. No special hardware needed. The tool runs on any platform from a laptop to a system with 32 (or even more) “off the shelf” test servers. That reduces system cost and makes it easy to scale to high capacities. It also makes the test tool much easier to modify and update than existing tools.

### FIELD OF INVENTION

This invention provides a high-performance software tool for testing networks.

### COMPUTER CODE APPENDIX

This specification has an appendix containing computer code provided on a CD-ROM. Appendix A contains test script code written in TCL for a sample test of a mobile data network. Appendix A consists of the MS-Windows ASCII file “capacity.txt” that is 109,381 bytes in size and was created on Aug. 22, 2004. This Appendix A is part of the disclosure of this invention.

### TABLE OF CONTENTS

GLOSSARY

OVERVIEW

TECHNICAL ADVANTAGES OF THIS TEST TOOL

Testing Modern Mobile Phone Networks

Provides Automated Testing on a Carrier Scale

Provides Rigorous, Real-World Simulations

Faster Development and Deployment of New Protocols

Can Test Both Control and Data Traffic

Easy Creation of Test Scenarios

Can Use Standard Hardware and “Open” Software

FINANCIAL ADVANTAGES OF THIS TEST TOOL

Better Testing Saves Money

Meets a Market and Industry Need

Cheaper to Buy and Cheaper to Operate

THE DRAWINGS

DETAILED SPECIFICATIONS OF A TEST TOOL

First Example—Mobile Data Network Test Tool
Hardware and Software Platform
   Test Administration Server
   Test Servers
   System Software
Parts of the Software Test Tool
   Graphical User Interface
   Parsing Engine
   Finite State Engine
Designing the Test
   Capacity Testing
   Performance Testing
   Traffic Testing
   Soak Testing
   Creating the Finite State Machines
   Creating the Test Script
   Setting Up the Test Configuration
   Running the Test
   Dynamically Linking the Protocol Stacks
   Reporting Results

Second Example—Test Tool for Load Testing a Website

Other Examples

CONCLUSION

CLAIMS

### GLOSSARY

The following is a list of acronyms and other terms and their meanings as used in this document.
CDMA Code division multiple access (CDMA) provides a technique of multiplexing, also called spread spectrum, in which several digital transmissions share the same frequency. For each communication channel, the signals are encoded in a sequence known to the transmitter and the receiver for that channel.
CDMA2000 The CDMA2000 standard provides the specifications for new “third-generation” mobile data networks based on the CDMA technique.
CHAP Challenge-handshake authentication protocol (CHAP) provides a way of authenticating the identity of a user on a PPP server. CHAP uses a three-way “handshaking” procedure, and provides more security than PAP. The identity of the user can be challenged at any time while a connection is open.
CPTS The CDMA Performance Test System (CPTS) is one example of this invention—a tool to test wireless data transfer networks that use the CDMA2000 standard.
CPU The central processing unit (CPU) controls the operation of a computer. Units within the CPU perform arithmetic and logical operations and decode and execute instructions. In a typical computer, the entire CPU is on a single chip like a Pentium IV.
CRC The cyclical redundancy check (CRC) provides a method for verifying that data was transmitted correctly.
DRAM Dynamic random access memory (DRAM) is a type of computer memory. Most computers have DRAM chips, because they provide a lot of memory at a low cost.
FA A switch (such as a PDSN) can often act as a foreign agent (FA) on behalf of home agents, enabling wireless service providers to extend mobile data services to a multitude of roaming subscribers. A foreign agent (FA) provides an access point that allows a mobile unit to access its home network through a remote network. The FA registers each mobile user with his or her home agent (HA) and provides a forwarding address for data delivery.
FSE A finite state engine (FSE) is an abstract engine that generates and executes FSMs.
FSM A finite state machine (FSM) is an abstract machine consisting of a set of states (including the initial state), a set of input events, a set of output events, and a state transition function. The function takes the current state and an input event and returns the new set of output events and the next state. Some states may be designated as “terminal states”. The state machine can also be viewed as a function that maps an ordered sequence of input events into a corresponding sequence of (sets of) output events.
GHz A gigahertz (GHz) is 1,000,000,000 hertz.
GPRS The general packet radio service (GPRS) is a new non-voice value-added service that allows information to be sent and received across a mobile telephone network.
HA A switch (such as a PDSN) can act as a home agent (HA) to enable wireless service providers to extend mobile data services to their subscribers on their “home” network.
HDLC The high-level data link control (HDLC) protocol provides a method to set up and manage a link to transfer data.
ISP An Internet service provider (ISP) provides Internet access to its subscribers.
IP The internetwork protocol (IP) provides all of the Internet's data transfer services.
IPCP The internetwork protocol control protocol (IPCP) is a protocol used to establish and configure the IP protocol over PPP.
LAN A local area network (LAN) is a network that connects computers that are close to each other, usually in the same building, linked by a cable or wireless connection.
MBps Mega bits per second (MBps) measure the rate of information transfer, and usually means 1,000,000 bits per second (or sometimes 1,048,576 bits per second).
MIP Mobile IP (MIP) provides a mobile IP protocol that allows mobile users to access the Internet.
MN Mobile nodes (MNs) are the cell phones or handsets used by a mobile network subscriber to access the network.
NIC A network interface card (NIC) is an adapter board that is plugged into a computer so it can be connected to a network.
PAP Password authentication protocol (PAP) provides a means of authenticating passwords using a two-way “handshaking” procedure. The validity of the password is checked at login. (See also CHAP.)
PCF The packet control function (PCF) in a radio access network controls the transmission of packets between a base station and the PDSN.
PDSN A packet data serving node (PDSN) is the switch used by a mobile data network carrier to provide network services to subscribers. A PDSN forms the heart of a wireless packet data network. For mobile subscribers, the PDSN becomes the point of entry into the wireless packet data network. The PDSN performs two basic functions:
   Exchanges packets with the mobile phone or other mobile unit over the radio network
   Exchanges packets with other IP networks To perform these functions, the PDSN typically interfaces with RNNs, with a server used for user authentication and session accounting, and with HAs for mobile data applications. In a typical configuration, each PDSN can support up to 4,000 PPP sessions. That means that a fully loaded chassis that can hold 16 PDSNs can support up to 64,000 PPP sessions.
PPP The point to point protocol (PPP) provides a protocol for communication between computers using TCP/IP that takes place over standard telephone lines, ISDN, and other high-speed connections. PPP can be used to connect a computer to the Internet, for services such as the World Wide Web and email.
RNN A radio network node (RNN) is responsible for handling the traffic to and from the mobile subscriber over the air interface.
RP or R-P The radio packet (RP) interface provides a path for traffic to be transported between the PDSN and the RNN.
SIP Session initiation protocol (SIP) is an emerging, IP-based protocol that is critical for deploying converged and next generation real-time voice, data and video communication services.
TCL Tool command language (TCL), sometimes pronounced “tickle,” is an interpreted programming language that is used for developing scripts and prototyping applications.
Unix A widely used “open” computer operating system designed to be used by many people at the same time (“multi-user”) for many tasks (“multi-tasking”). Unix has TCP/IP built-in, and has become the most common operating system for Web servers on the Internet and for test servers.
VPN A virtual private network (VPN) provides a means by which certain authorized individuals (such as remote employees) have secure access to an organization's intranet by means of an extranet (a part of the internal network that is accessible via the Internet). A VPN can be far less expensive than using actual private lines in a wide area network (WAN).
VPRN A virtual private routed network (VPRN) is a type of virtual private network (VPN). This network architecture isolates the IP addressing within each VPN from the rest of the network. Although a given customer's IP addresses are used to route its traffic, the customer's routing tables and forwarding choices are limited to only sites within the VPN.
WAN A wide area network (WAN) is a network in which computers are connected to each other over a long distance, using telephone lines and satellite communications.
Wi-Fi Wireless fidelity (“Wi-Fi” or “WiFi”), also known as wireless networking, is a set of standards for computers to join together in wireless local area networks (LANs) or obtain access to the Internet based on the IEEE 801.1 1 specifications.
XML Extensible markup language (XML) is a programming language that allows Web developers to create customized tags that will organize and deliver content more efficiently. XML is a meta-language, containing a set of rules for constructing other markup languages. By allowing people to make up their own tags, it expands the amount and kinds of information that can be provided about the data held in documents.

### OVERVIEW

A young man walks down the street, cell phone to his ear. He takes a few steps and asks “Can you hear me now?” Then a few seconds later, “Good!” A few more steps. “Can you hear me now?” “Good!”

As a television commercial has it, a mobile phone carrier tests its network that way. The young man seems to walk across the entire United States, a few steps at a time. In one commercial, he walks around a zoo so much that a monkey starts to ape him, putting a banana to its ear and jabbering away.

That makes for some funny television commercials. And it may work to identify a few “dead zones” in a cell phone network. But it's not realistic for most testing. In reality, adequately testing all features of a modern mobile phone network that way would take months (if not years) and take thousands of manual testers.

Instead, high-performance, automated testing tools with “virtual users” must be used. Only they can rigorously test today's huge, high-capacity, complex networks. These tools exist. But existing test tools are expensive, hard to use, unable to scale easily, and unable to-simulate real-world conditions accurately.

The high-performance test tool of this invention can rigorously test any kind of network that uses protocols to control and send traffic. This includes anything from stress testing the capacity of an Internet site to “soak testing” a mobile data network. Unlike existing test tools, this test tool can easily be scaled to run real-world traffic models. Almost any real-world conditions can be simulated.

A mobile data network test tool provides one example of a test tool of this invention. This test tool can simulate mobile phone users starting calls (activations), moving from one cell to another (handoffs), sending data (bearer traffic generation), and ending calls (deactivations). All of these calls can be for short or long durations.

This mobile data network test tool (described in detail below) provides a comprehensive test system that simulates millions of mobile data subscribers. All these “virtual users” can use the network simultaneously, and they can use all possible ways to access the network. Using this test tool, a test operator can simulate subscriber loads ranging from a small rural town to the largest metropolitan city.

This mobile data network test tool delivers impressive numbers. With a total capacity of over 6 million simultaneous sessions and data traffic capacity of 16 gigabits per second, this test tool can stress to breaking even the largest networks. No existing test tool can match this test tool's raw throughput coupled with the meaningful data transfers.

This test tool emulates all key wireless core packet data network elements—mobile nodes (the actual mobile data phone), foreign agents, home agents, packet control functions (PCFs), secure gateways, and network hosts. This test tool can do both call control and data traffic. That means that this test tool provides “real-world” emulation of millions of mobile data phone users in various stages of activation, deactivation, and “hand-off” between cells—all while transmitting and receiving real-world application data.

This huge capacity does not require expensive custom hardware. Just 32 standard PC (such as Dell) servers running open system software, in this example Linux and an interpreter for the TCL language. This test tool's modular architecture makes it easy to scale by just adding test servers. By adding more test servers, this test tool can scale to get any desired test capacity.

That huge capacity allows both carriers (Sprint, AT&T and others) and equipment vendors (Nortel Networks, Cisco, and others) to perform sophisticated testing unmatched by any existing test tool. For example, if a carrier wanted to simulate an unusual situation—such as people using their mobile phones to get information just after the World Trade Center tragedy on Sep. 11, 2001—with this tool it could.

Even so, this test tool costs much less than existing tools. It costs much less to operate and update. An existing test tool may require months and $200,000 to $300,000 to update so it handles a new feature or updated protocol. In some cases, this same change to this test tool can be done in 2 to 3 days at a cost of $10,000 to $20,000.

This test tool is easy to use. An operator can easily specify test parameters—using an intuitive graphical user interface—without writing any underlying test scripts. Results are reported in an easy-to-use fashion.

### TECHNICAL ADVANTAGES OF THIS TEST TOOL

The test tool of this invention can be used to test any kind of network that uses protocols to set up connections and to send and receive data. One example of a test tool of this invention will be discussed in detail here—a test tool for a CDMA2000 mobile data network. Another example described here is a test tool for load testing a Website on the Internet.

Testing Modern Mobile Data Networks

First, the need for high-capacity network test tools must be put into context. Why do test tools need to have high capacity? Because the real-world networks being tested have to provide vastly more capacity every year.

As one example, mobile phone traffic has exploded in the last decade. An estimated 1.35 billion people worldwide now use mobile phones. Once a rarity, mobile phones have become a necessity for over 160 million Americans.

Other countries rely even more on mobile communications. In some countries most of the people have a mobile phone. In Japan, the figure has reached 62.7% of the population. In fact, many Japanese have replaced their landline with a mobile phone, and no longer have regular landline phone service.

With this explosion in traffic, modern wireless networks need to handle millions of simultaneous calls, generating many thousands of new calls every second. Once limited to voice, mobile phones now handle more and more data as well.

To handle this traffic, wireless telephone networks have become huge and complex, requiring a big investment in equipment. To add to the size and complexity of the networks, mobile phone makers continually offer advanced features.

As wireless telephone markets mature, most of the growth in sales comes from selling newfangled phones to existing users. So mobile phone makers are busily stuffing new features into mobile phones—cameras, text messaging, Internet access. No longer is mobile phone traffic limited to voice.

All this puts enormous strain on networks. A huge and complex system naturally has problems and breaks down. But system problems, particularly outages, can be a nightmare. They can cost a fortune and destroy a carrier's reputation.

And just because a system may be huge, expensive and complex does not mean that it is a quality system. Indeed, the opposite is true. The simpler a system is, the more reliable it tends to be. Complex systems tend to be plagued with problems.

As new features come on the network, even more problems arise. Problems that have long plagued mobile phone networks persist and worsen with higher penetration and advanced features. Busy signals. Sloppy service. Static. Dropped calls. Dropped data.

Take New York City, for example, the largest mobile phone market in the country. In the vicinity of the city, there are said to be nearly 200 “dead zones”—areas of heavy interference, frequent dropped calls and failed connections. The major suspect? Service providers who have signed up too many users for their network and overwhelmed their networks with call volume.

As problems with networks become severe, people become upset. That may lead to legal problems as well as losing subscribers. Indeed, the problem with dead zones in New York City has led to an investigation by US Senator Charles Schumer's office.

Thorough testing can help reduce or eliminate these system problems. Service providers can know the exact limitations of their networks by using load or capacity testing, performance or feature testing, stress testing, and soak (or long-term) testing. Problems can be discovered and solved before a network goes live, or at least before the problem occurs on the actual network.

But thorough real-world testing can be difficult. With existing test tools, accurately simulating real-world levels of connection traffic and data traffic can be so expensive and time-consuming as to be impractical.

Provides Automated Testing on a Carrier Scale

A network test tool must be able to simulate a huge amount of traffic, and simulate it as close as possible to reality. What are the problems with current test tools? They do not do any of the following well:
scale to millions of users
generate thousands of new calls per second
accurately simulate real-world traffic
run on standard servers (not custom equipment) on open operating systems
perform both data and control testing
perform all kinds of testing: load or capacity, performance or function, stress, and soak
be easily updated or modified
be cost-effective

The test tool of this invention provides these key features. It provides unmatched scalability, greatly improved flexibility and ease of use, and unparalleled emulation of real-world conditions.

Words like “unmatched” and “improved” may be easy to say. Actual figures tell the real story. Turning to actual figures, let us consider one example of this invention, a new high-capacity test tool for testing CDMA2000 mobile data networks on a carrier scale.

With this test tool, up to 6.4 million “virtual users” can rigorously test nearly every feature of the network. Yet the tool can achieve this capacity using only 32 normal, non-proprietary servers running the Linux operating system. And each test server can generate many thousands of sessions per second. In some models, the tool can generate 4,000 sessions per second, in others 2,000, in others 1,500, and in others, 1,000. That can be 100 times (or more) faster than existing tools.

Network equipment manufacturers like Nortel Networks can use this high-capacity tool to benchmark their systems before carrier trials. Service providers like Sprint—the carriers themselves—can use this test tool to keep up with an increasing customer base using increasingly demanding applications.

Scalability does not just mean high capacity. This test tool can run on almost any platform. It can run on a modestly priced laptop or on a combination of 32 high-end test servers. That allows the test tool to be used in a cost-effective way. The same test tool used by an engineer in the field using a laptop can also be used to stress-test a carrier-scale network of six million users.

On the high end of the scale, adding more test servers or using bigger machines as test servers can scale capacity higher. Only processor speed and memory size limit the capacity of the test tool. In theory at least, increasing the number of test servers will increase both these limiting factors, giving this test tool almost unlimited capacity.

Provides Rigorous, Real-World Simulation

The test tool of this invention can model real-world traffic. This allows the customer to identify problems and bottlenecks in a lab environment so that issues are addressed prior to network deployment. This significantly reduces the time required to reproduce and correct problems seen in the network.

Wireless carriers and equipment vendors share the goal of continually testing and “benchmarking” their networks and equipment. Testing under laboratory conditions does not present much of a problem. Test scenarios can be created relatively easily that, used during system development, can identify major problems so they can be fixed prior to deployment.

The problem has been how to simulate all the various real-world conditions that will put the greatest stress on the performance of the equipment, or network. As one example, vendors providing CDMA2000 equipment lack the necessary test tools to determine the performance of their platforms adequately.

In particular, vendors and carriers have no way to emulate real world traffic patterns accurately to determine how their equipment will work in a live network. Existing test tools cannot generate enough control messages to establish sessions at a rate that will stress the vendor equipment. Thus these tools cannot reproduce the same traffic loads that carriers are seeing in their networks.

This results in poor performance of the equipment in a live network and limits the vendor's ability to solve problem prior to commercial release. Carriers deploying CDMA2000 networks lack the necessary test tools to evaluate vendor's equipment or to model their networks prior to deployment. This results in poorly engineered networks and dissatisfied end users. Carriers are unable to forecast growth requirements adequately or to budget properly for needed network expansion.

Both vendors and carriers want a test tool that combines both control traffic and data traffic generation in one platform. They want test equipment that can significantly out perform the existing packet data service node (PDSN) capabilities. They want a tool that is capable of running various types of traffic models simultaneously, at rates that exceed the capacity of the systems under test. This will allow them to recreate real world traffic patterns and identify the issues that must be addressed in future product releases.

With the test tool of this invention, any real-world conditions can be simulated. This test tool can perform activations, handoffs, bearer traffic generation, and deactivations for short or long durations. Models can be created to test any function or feature of the network, all at the speeds and scale set out above. This test tool can emulate any real-world conditions that could stress the network to the breaking point.

Faster Development and Deployment of New Protocols

Preferably the test tool of this invention will be written in software only. That allows changes and updates to be easily made to the test tool and the protocols it uses. While a “software only” test tool brings many benefits, a test tool of this invention may also be created using hardware.

Using software for most (or all) of the test tool, as in the example described here, brings many benefits. For example, the unique software architecture of the test tool of this invention allows for faster development and deployment of new protocols for the test tool.

With this test tool's software architecture, new independent software protocol stacks can be developed and tested without any change to the test tool or existing protocol stacks. Using a dynamic linking algorithm, the test tool can then use the new independent protocol stacks in conjunction with the previously existing stacks.

In addition, by implementing each independent protocol stack in software, new high-level protocols can be deployed rapidly through the reuse of the lower level protocols without modification. Traditional hardware implementations of these stacks require lengthy hardware modifications for deployment of new high-level protocols and to address on-going standards revision for each protocol level.

This brings many benefits. This architecture allows developers to work independently on the development of new protocols without risk of damaging the existing software. This results in a more rapid deployment of new protocols and significantly reduces the time to market for new test capabilities. It also allows the independent modification of each protocol layer as the standards bodies revise and modify each protocol layer.

In terms of flexibility, the method can be modified very easily. In traditional systems, changes to a test tool typically require a new version to be created, tested and issued. With this test tool, changes can be made much easier.

Can Test Both Control and Data Traffic

Network test tools must test two things: setting up a vast number of connections between “virtual users” and the system under test, and then sending data through those connections. In a mobile data network, that means controlling connections for a vast number of calls from mobile devices (dialing or otherwise initiating a connection, moving from cell to cell, and hanging up), and sending data traffic through the connections.

Using a unique dynamic linking algorithm, the test tool of this invention allows the rapid passing of connection control traffic and data traffic between multiple independent protocol stacks. The dynamic linking algorithm provides a method of chaining multiple independent software protocol stacks in real time. This allows the software to create complex signaling protocols, such as CDMA2000 Simple IP, CDMA Mobile IP, and GPRS Tunnel Protocol, from a set of independent software protocol stacks.

This dynamic linking algorithm allows each protocol stack to pass control messages up and down the linked stacks rapidly. The test tool thus achieves throughput of meaningful data that is unobtainable from a traditional hardware implementation of the lower level protocol stacks.

This dynamic linking of independent protocol stacks allows the test tool to achieve control-signaling speeds that are orders of magnitude higher than traditional hardware and software implementations. These speeds are essential for modeling, for example, real-world wireless data networks connection control traffic and data traffic using a single test tool.

Also, the ability of the test tool to generate both connection control data and data traffic brings other benefits. This allows the customer to use a single test system, improving the productivity of its test organization and reducing its capital investment in test equipment.

Easy Creation of Test Scenarios

Creating test scenarios using a typical network test tool can be tough. One problem is that it requires a lot of skilled programmer time. That gets expensive. Another problem—the test script cannot be easily modified. For example, to change the data sets used to test the network, the test script itself must be modified and retested.

The test tool of this invention allows test scenarios to be easily created. The test operator enters the parameters for the test into the test tool. He or she need not write the test script. Instead, the test tool features a powerful, easy-to-use graphical user interface that allows a test operator to quickly set up complex test sessions without knowing anything about the test script language. These sessions can be saved, modified, and reused, allowing quick and easy creation of numerous scenarios covering all that the test planner wants to test.

No longer need the test operator write the test script, try it out, and then make changes to it. The flexibility and economy this provides makes the operation of this test tool much easier than existing test tools.

The test tool of this invention provides a unique software architecture that allows the dynamic creation of complex wireless packet data test scenarios, based on a custom TCL scripting language that combines XML messaging for the definition of key test configuration information.

This test tool uses an extended TCL scripting language combined with the use of XML messaging between a test administration server and the test servers. That makes this test tool able to create complex test scenarios through the use of dynamically linked independent protocol stacks.

The use of XML messaging allows the graphical user interface to remain unaware of the specific configurable parameters. That creates an independent interface that provides the user with the proper prompts and range checking required for each unique test case.

The entered parameters are then passed to the test servers, where the custom TCL script controls the dynamic linking of the required protocol stacks, providing the necessary protocol parameters to each protocol layer, again allowing each protocol layer to remain independent and unaware of the actual test scenario. This allows the creation of new complex test scenarios without modification of either the graphical user interface or the independent protocol stacks.

This use of the graphical user interface to control the TCL test script allows for rapid deployment of new complex test capabilities with no modification of the existing software. This allows the test tool to continue to provide new test capabilities as the wireless packet data networks evolve and new traffic patterns emerge.

Can Use Standard Hardware and “Open” Software

The test tool of this invention can run on standard PC (e.g. Dell, or similar servers) running the Linux operating system. The “open source” TCL interpreter provides the test script language. Using commercially available hardware and “open source” software greatly reduces costs. It also allows for easily increasing or decreasing needed capacity.

Using custom hardware for a test tool can improve speed and capacity for some functions, but at the expense of cost and flexibility. To try to meet the high capacity required of network test tools, existing test tools use special hardware to quickly generate large numbers of protocol stacks. Custom hardware is more expensive due to low volume, not just because it is custom. The test tool of this invention uses high-volume commercial platforms that provide the best cost/performance.

Custom hardware significantly boosts the costs and significantly reduces the flexibility of the test tools. Scaling hardware tools to generate more protocol stacks at a faster rate increases complexity and cost dramatically. Even so, existing test tools cannot achieve the high throughput of meaningful data required to test modern networks rigorously.

### FINANCIAL ADVANTAGES OF THIS TEST TOOL

Better Testing Saves Money

Better testing of networks saves money. For example, for the vendor the return on investment by using the test tool of this invention is based on productivity improvement in their test organization and the ability to identify defects earlier in the development cycle. Typically productivity improvement can be conservatively estimated at 40%. If a customer currently has 10 test engineers, this equates to a savings of 4 test engineers, or approximately $600,000, assuming a $150K loaded labor rate.

The larger return on investment is in identifying defects during the design and test cycle. Industry estimates show that the cost of correcting a field defect can be four to ten times higher than if the defect is identified during development. And that does not count the cost of angering customers by the defective product

For the carrier, the return on investment is based on productivity improvement in its test organization. A carrier may also see investment savings in capital equipment and engineering costs required to reengineer its networks as traffic patterns change and the real performance of the network equipment is identified. Finally, customer satisfaction may be the biggest—and financially the most beneficial—positive.

Meets a Market and Industry Need

Those in the industry recognize the benefits of the test tool of this invention. One research manager in the mobile and Wi-Fi infrastructure industry noted the advantages of the CDMA2000 Performance Test System, one example of a test tool of this invention. “As new CDMA2000 services are rapidly being rolled out, expediting equipment testing is critical to timely service delivery. A test tool like the CDMA2000 Performance Test System could shorten the testing cycle and improve time-to-market for products.”

Based on a report by Deutsche Bank dated Jun. 27, 2003, there were then 30 carriers that have or are planning to introduce CDMA networks. The vendors producing PDSN equipment include Nortel Networks, Starent, Cisco, Motorola, UTStarcom, NEC, and others.

The average carrier will need two test servers to model its network based on current traffic patterns, and the average vendor will need 15 test servers to support its design and test organizations as its initial investments. Each carrier and vendor will also purchase portable versions of the test tool for field support, first office applications, and installation support.

That makes a sizable market for CDMA test tools. Currently no other tool manufacturer provides a test tool that can meet the customer's needs. The CDMA test tool remains the only carrier-scale test tool available with the features and performance needed by vendors and carriers.

The CDMA test tool will be available just as the evolution to 3G CDMA2000 technologies is picking up. The evolution of GPRS put some pressure on the CDMA operators. With upgrades to CDMA2000 technologies, such as EV-DO, the volume of data over CDMA networks could surpass that of GPRS networks. There are now more data subscribers, and they are pumping more data traffic onto these networks, which creates the need for better performance tools.

For example, in 2004 Verizon Wireless's national expansion plan for EV-DO, a new service which likely will be offered at the same price as the carrier's current 1X RTT data service, will spur subscriber and traffic growth. To handle this growth as it occurs, the CDMA test tool includes emulation and performance elements for benchmarking both current and next-generation mobile IP and simple IP core infrastructure. It allows testing of home agents and foreign agents separately or as an integrated architecture.

Cheaper to Buy and Cheaper to Operate

The test tool of this invention can be dramatically cheaper to buy and to operate than existing test tools for the following reasons.
1. This test tool is a “software only” test tool that runs on standard hardware and an “open software” operating system. That makes hardware and software platform costs less than for tools requiring proprietary hardware.
2. The emulation capabilities of this test tool make it more flexible than other test tools. For example, this test tool can test both connection control and data traffic. With other test tools, typically one tool is needed for connection control testing and another for data traffic testing. As another example, this test tool can emulate all components of the network—for the CDMA test tool, that means PDSN foreign agents (FAs), home agents (HAs), and network hosts. This allows for more effective utilization of lab equipment and reduces the capital expenditure and ongoing support costs associated with a test lab.
3. This test tool can be operated by just a test operator who need not worry about writing the test scripts. Other test tools typically require that a test operator work with a skilled test developer to write a test script.
4. Changes to this test tool can be made easily. A new protocol can be added without any changes to the test tool software or the existing protocols. That means that only the new protocol needs to be tested. Development time, and more importantly expense, is drastically reduced for new protocols or modifications to existing protocols. As mentioned above, the difference in making a modification may be as striking as 2 to 3 days compared to months, and $10,000 to $20,000 compared to $200,000 to $300,000.

### THE DRAWINGS

One or more examples of a carrier-scale test tool are shown in the drawings. A brief description of each drawing follows:

FIG. 1 shows one example of a configuration of a test tool of this invention, a benchmark CDMA2000 Simple IP PDSN performance test.

FIG. 2 shows a block diagram of one example of a test tool of this invention interacting with a network system under test.

FIG. 3 shows a block diagram of one example of the parsing engine design.

FIG. 4 shows one example of the implementation of finite state machines.

FIG. 5 shows one example of a test tool of this invention being used to simulate the Internet to test a Website.

FIG. 6(A) and (B) shows two prior art methods of building protocol stacks, and FIG. 6(C) shows one example of building a protocol stack according to this invention.

### DETAILED SPECIFICATIONS OF A TEST TOOL

### FIRST EXAMPLE

### Mobile Data Network Test Tool

One example of a high-capacity test tool of this invention is the CDMA Performance Test System (CPTS) available from Spirent Communications. Scientific Software Engineering, Inc., the owner of this patent, designed the CPTS.

The CPTS is the only mobility test tool that simulates real-world traffic models for CDMA2000 mobility packet data networks. It operates on Spirent's Mobility 2500 platform. It can also be operated on nonproprietary hardware systems.

This breakthrough test tool provides “real-world” emulation of the demands subscribers put on the network—millions of users using a variety of mobile data devices in various stages of activation, deactivation, and moving between cells, as they transmit and receive data traffic. The CPTS emulates all of the key wireless packet data network elements and combines control traffic and data traffic simulation.

The CPTS allows PDSN equipment vendors to determine definitively the performance characteristics of their equipment under “real-world” conditions. It allows service providers to measure the performance of their networks and to model new features and services in a lab environment. In addition, it enables service providers to evaluate vendor's equipment using the same traffic models they expect in the live network.

The CPTS system provides a comprehensive nodal and end-to-end test capability for PDSNs supporting both open radio-packet (RP) and closed RP protocols. The nodal test capability includes both FA nodal testing and HA nodal testing.

The CPTS system provides a single test system that covers several testing concepts currently executed by a variety of test systems used for testing PDSN systems. The CPTS system provides a full range of test capabilities including capacity, performance, traffic, and soak tests.

The CPTS capacity significantly exceeds the loads generated by other test tools. An equipment vendor, carrier, or other user can use the test tool to do many things:
Simulate real world traffic patterns for long periods.
Stress the equipment at maximum loads.
Identify the network equipment's capacity for session activations.
Model handoffs, deactivations, and data throughput for each supported access model (such as Simple IP, SIP VPN, Mobility IP, MIP VPN, and MIP Reverse Tunnel).
   Hardware and Software Platform

The CPTS system may be deployed in either of two configurations. The first is for static lab use. A standard static lab system consists of six servers, with one server functioning as the test administration server, and five servers functioning as test servers. However, from one to 32 test servers can be used in a single configuration.

The second deployment is a single laptop option that is ideal for remote use such as installation testing or field troubleshooting. The laptop configuration includes the client software, the test administration server software, and one test server software package, all on a single platform, for use by a single user.

Test Administration Server. The test administration server controls the test servers, user accounts, and the test libraries. In the static lab-use test system, any standard server can be used for the test administration server. This examples uses a Dell 2650 server, with a single 2.8 GHz Xeon microprocessor, 2 GB of RAM, two 10/100/1000 MBps Ethernet NICs, three 10/100 Mbps IPSec Ethernet NICs, and a single 36 GB hard drive.

In the mobile test system, any standard high-performance laptop may be used as both the test administration server and the test server. This example uses a Dell laptop with a 1.6 GHz Pentium M, 1 GB of RAM, two 10/100 Mbps Ethernet NICs, and a single 40 GB hard drive.

The test operator communicates with the test administration server via an Ethernet interface utilizing a LAN connection. Any client PC or workstation located anywhere on the LAN can be used by the test operator to communicate with the test administration server.

The CPTS provides a web-based client interface that is accessible by any standard Internet browser with a Java plugin, running on any operating system with Java support. The only installation required on the client workstation is the Java Run-time Environment JRE 1.4.2.

Test Servers. The test servers perform all of the network node emulation and control messaging, collection of operational measurements, and initiation and verification of data traffic. The CPTS system supports up to 32 test servers per system.

Here again, any standard PC server can be used. In this example, just like the test administration server, each test server is a Dell 2650 server, with a single 2.8 GHz Xeon microprocessor, 2 GB of RAM, two 10/100/1000 MBps Ethernet NICs, and a single 36 GB hard drive.

The test servers communicate with the system under test via an Ethernet interface utilizing either a direct connection or a connection via a network (in other words, via one or more routers). The test servers communicate with the test administration server via an Ethernet interface utilizing a LAN connection.

The test servers each run finite state machines driven via TCL files downloaded from the test administration server.

System Software. Each of the servers runs Linux 2.4.20 (Redhat 9.0) as the operating system. Each server also runs an interpretive script language. This example uses TCL with some custom extensions.

Parts of the Software Test Tool

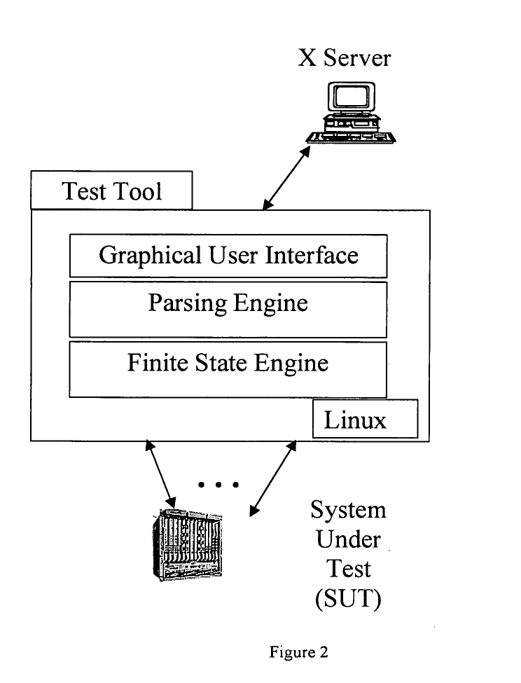

The CPTS has three main functional parts of this “software only” test tool: a graphical user interface, a parsing engine, and a finite state engine. FIG. 2 shows these parts of the CPTS, interacting with the system under test.

Graphical User Interface. The CPTS features a powerful, easy-to-use graphical user interface that allows a test operator to set up complex test sessions quickly. The test operator accesses this graphical user interface on the test administration server using a standard web browser. Test definition is accomplished through choices made in the graphical user interface. The test operator no longer needs to write test scripts.

The CPTS provides the ability to develop standard tests that can be executed by any system user. A test operator can customize pre-programmed test cases with modifiable test parameters. He or she can combine multiple test cases into a test session.

Each test session can be saved, modified and reused, allowing quick and easy creation of numerous scenarios covering the various CDMA2000 access models. Test sessions can be saved in the user's private library or in shared system libraries available to all users. A test operator can reliably repeat a test session and compare the results to a previous execution.

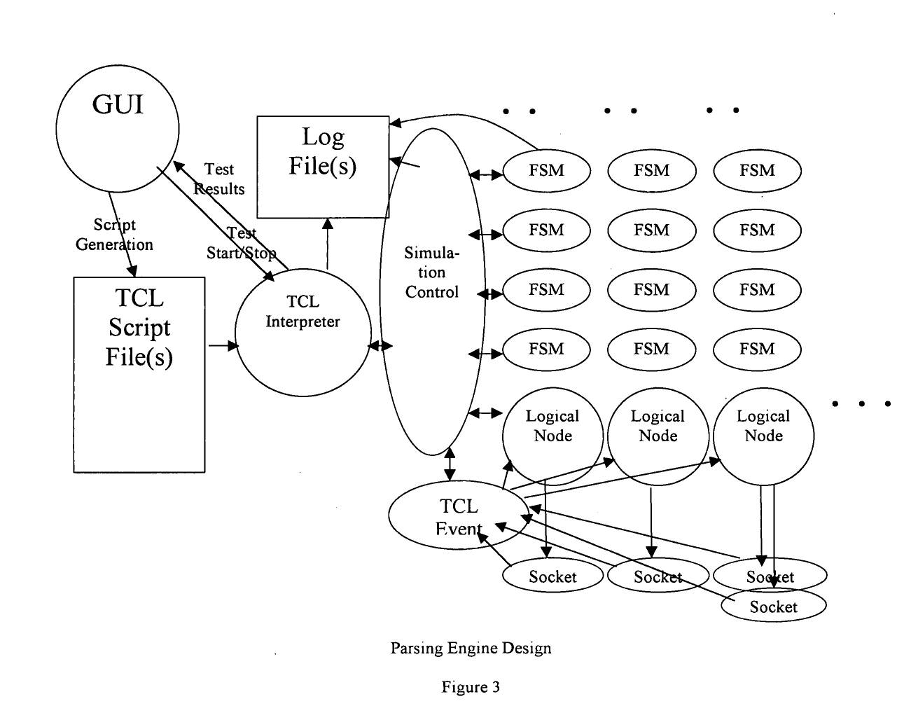

Parsing Engine. The parsing engine consists of a TCL interpreter that parses a TCL test script. Based on that script, the parsing engine then calls the appropriate C++ or TCL functions to provide the functionality requested. This interpreter provides function calls to add new commands; therefore there will be no changes to the base TCL software. FIG. 3 shows an example of parsing engine design.

As can be seen in FIG. 3, the parsing engine also contains simulation control software. This simulation control software is a collection of functions that are inserted into the TCL interpreter as TCL extensions, and observer functions called by the finite state machines (FSMs) to invoke trigger scripts.

The parsing engine operates as follows. The test administration server sends a TCL test script to each test server. Each test server has a parsing engine that must parse the test script to generate the appropriate protocol stacks for the test being conducted. The test script may require any of several things.

For example, the parsing engine may find that the test script calls for capacity testing, which means generating vast amounts of traffic. Or the test script may focus on specific data rate control per session, packet size control (fixed or random), or packet rate control (fixed or random). All these variables must be parsed by the parsing engine to generate the appropriate protocol stacks.

In some cases, the parsing engine finds that performance testing must be performed. In that case, the test script calls for various loads to be generated. Response times and timing under those loads is measured.

One important thing to test with networks is the ability to deal with errors. The parsing engine has to be able to generate protocol stacks that contain errors. This test tool has the ability to inject any message error at any time. For example, the following errors can be simulated:
Bad parameter
Bad length, such as length set to zero
Corrupted header
Address spoofing (invalid mobile device address)
Jumbo packets (oversize packets requiring fragmentation)
Runts (simulate lost packets)
Bad CRC—assuming HDLC CRC (corrupt CRC code)

Protocol compliance testing requires that the test script be able to exercise any feature of the protocol, and set or verify any parameters and messages. Multiple node simulation must be available, so that hand-off testing can be done.

To test CDMA2000 networks adequately, the parsing engine must have control over:
IP Source/Destination Address/Port
OpenRP Sessions
PPP (LCP/IPCP/PAP/CHAP)
MIP

Timing must also be accurately tested. Delays in processing must be simulated, to test the ability to do retries. The responses of the system under test must be measured. The system under test must be tested to limit, so that the maximum number of sessions and the maximum number of tunnels can be determined. Session timeout limits must also be tested.

An important part of the parsing engine function is the ability to verify results. Not only must the appropriate protocol stacks be generated, but also the responses from the system under test must be verified for correctness.

The main goal in creating the parsing engine is high throughput. This can be achieved by making it unnecessary for the test script to control normal call progress. In addition, the test script need not control the critical path for capacity testing. Instead, event triggers and timers allow the protocol stacks to operate independently without control. These triggers and timers are discussed in detail below.

The parsing engine must also be able to assume complete control over any aspect of the testing through the test scripts. While the test scripts do not control many aspects of the test, the test scripts do control simulation setup and error injection. The test scripts are also used to verify success or failure.

A complex language must be used for the test scripts to enable all this. Not only must the simulation environment be set up and controlled, but the test script must enable interaction with the finite state machines to enable error injection, message parsing, test progress logging and test result verification. That requires a language that provides for:
Looping
Variables
Comparison
Conditional execution
Formatted output

In this example, TCL was chosen as the best choice to provide these complex language features. That allowed the CPTS to be created without having to reinvent the wheel. TCL has several important advantages:
TCL is an “open source” scripting language.
TCL can be easily extended, and extensions can be in TCL or C or C++ code.
TCL is well documented and tested.
TCL is very efficient.
In the CPTS, no modification to TCL functionality is required, so all terms of the TCL open license are met. The only extensions that need be made are those to allow interaction between the CPTS code and TCL scripts.

Finite State Engine. The CPTS has a finite state engine (FSE) running on each test server. Each FSE can support multiple FSMs per session. The FSE allows trigger points to be programmed so that a trigger is activated either by an incoming event or a state transition. Each of the CPTS protocols (such as Open RP Sessions, PPP Layers, etc.) is a separate FSM running on the FSE.

The FSMs are a collection of finite state machine implementations based on the FSE that implement all of the protocols required for the desired testing. For example, OpenRP, PPP, MIP, and data traffic generation will all be implemented as FSMs. This can generally be easily done, since the basic definition of many protocols is a state machine.

The FSE provides the FSMs with base functionality that allows the simulation controls (driven by the test scripts) to program trigger points in the FSMs. A trigger is defined by an event type (such as a particular received message type, timeout or state change) and state identifier.

The FSE creates logical nodes, which are objects created on command from the test script to represent a system or mobile device to the system under test. An OpenRP PCF is an example of a logical node. In order to test mobility, multiple logical nodes are required. The FSMs created are configured to be associated with a logical node, or another FSM.

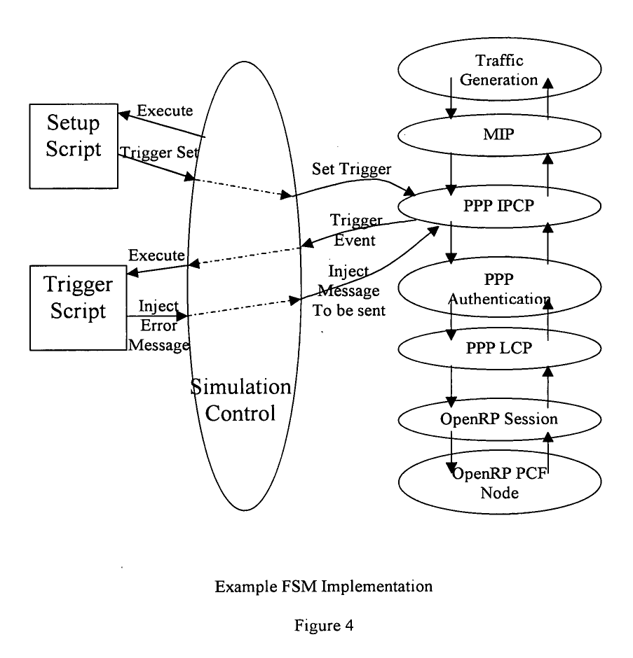

FIG. 4 shows one example of the implementation of finite state machines for a protocol stack. As can be seen in this figure, simulation control is kept simple because it need be invoked only when a trigger is activated.

When a programmed trigger is activated, the simulation control is notified and it can then perform any actions as defined by the test scripts. For example, a trigger could signal the simulation control to send a corrupted message or force a state change in order to test error processing in the PDSN. When FSMs are linked, a trigger from one FSM may be passed to another to invoke some action in a different layer (e.g. session establishment).

An FSM with no active trigger simply implements the normal operation of that particular protocol. This allows the simulation control to start many calls that will operate normally. (i.e. minimal triggers) Those calls will take very little processing capacity since they need not be controlled, only monitored.

The simulation control can set triggers in a select few FSMs as required in order to carry out the desired tests. By using triggers only when necessary, high throughput can be achieved because processing time has been minimized.

Designing the Test

The CPTS can perform several different types of test. The main types are capacity, load, performance and soak testing. The test operator can choose from among these different types of test when using the graphical user interface to the CPTS.

Different companies will want different tests. For example, a network equipment vendor like Nortel Networks will focus on testing its equipment to see if it works, making modifications to the equipment, and then retesting the equipment after modification. Proper operation is the key, not high capacity.

By contrast, a carrier like Sprint will focus more on stressing and feature testing. Before new releases or new equipment go live, the system must be tested for capacity and performance without error. The carriers need to do long-term soak tests as well, to see if the system develops memory leaks or runs without crashing for extended periods (tests can be configured to run indefinitely).

Capacity Testing. How many users can use a CDMA2000 network at one time? The CPTS provides capacity test suites that can verify the maximum number of simultaneous sessions a PDSN FA and HA can support. In addition, the CPTS capacity test suites allow the user to determine the effect of various test configurations on memory and CPU usage within the PDSN FA and HA.

Performance Testing. What are the maximum processing rates at which the PDSN FA and HA can handle various external requests? The CPTS performance test suites can provide real-time statistics of the processing rates and delays that occur at various levels of capacity. They can also test the FA and HA stability and reliability by sending external requests at rates that exceed the supported rates.

Traffic Testing. Can the PDSN FA and HA handle all types of data traffic at the supported rates? The CPTS traffic test suites can generate a variety of data types at various rates supported by the PDSN FA and HA. The data traffic sent and received can be analyzed and checked for errors. Overloading the data traffic can test the reliability and stability of the system under test.

Soak Testing. Does the PDSN FA or HA fail over long duration tests? The CPTS soak test suites can test the stability and reliability of the PDSN FA and HA over a long duration as well as under stress. To simulate complex traffic models, the test operator may select any soak test scenario or a combination of scenarios. To increase the traffic load, the test operator may use multiple test servers for the soak tests, running various test scenarios.

The primary difference in soak testing is that data is collected over a long period of time at periodic intervals, with the results presented in an easy to use format. On-going results are presented, with final results tabulated at the end of the test period.

The soak test suites can perform a variety of access model simulations with mobility events and data traffic as desired. The sessions will continue to be activated and deactivated throughout the duration of the test. In addition to the normal test scenarios, the user may select error case scenarios that will result in periodic error injection at selected intervals.

The comprehensive soak test suites give the test operator the high capacity needed to create “real world” scenarios for heavy load and long duration stability tests. Just as in a live network, the CPTS can generate variable session rates, mobility events, data traffic with application protocols, and error scenarios. These tests can be run indefinitely, or can be configured to run for a finite amount of time and then end gracefully.

Creating the Finite State Machines

In a wireless network, several protocols must be used to make the trip from sender to receiver. A typical protocol stack for passing data from a wireless network PCF to a PSDN looks like this:

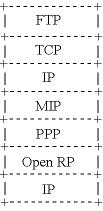

A load generator can generate many thousands of these protocol stacks and send them off to the network. To the network, this traffic will appear normal. So when testing the PDSN of a carrier or equipment maker, the PDSN will respond to this traffic the same way as though it were actually connected to a network user's mobile device.

But by using a test tool to “drive load” into the network at a protocol level, a small number of computers (or “load generators”) can be used to simulate many thousands of users. You do not need thousands of cell phones to generate the thousands of calls that are simulated.

With protocol testing, maximum scalability becomes key. A test tool that can minimize CPU consumption for each virtual “user” enables more users to run on each load generator machine. Test tool benchmarks typically give the number of simultaneous virtual user sessions that can be generated per test server. A high-capacity tool will generate more sessions per second for a given machine. So the two criteria are capacity and speed.

During execution of the test, the CPTS generates an FSM to represent each protocol in the protocol stack. The FSE generates the FSMs in real time in accordance with the test script.

To allow the FSE to generate the FSMs, each supported protocol must have an FSM coded in C++. In addition, each FSM must have extra code to support event triggers, timers and dynamic linking.

By building this extra code into the FSMs for each type of protocol, the FSMs can be dynamically linked to each other in real time. That increases flexibility and reduces required processing time, allowing the CPTS to generate exceptionally high throughput and capacity.

All FSMs should be written with a common set of triggers and functionality that allows them to be linked. That will allow any FSMs to be linked together in a standard way. Then when the FSMs are dynamically linked, events can propagate between the layers without entering TCL. These same triggers (and others) may also be monitored by the TCL in order to determine what is going on down in the FSMs.

Creating the Test Script

The CPTS creates the TCL test script for a particular test by combining preset TCL code sequences according to the test type and test parameters chosen by the test operator. The test operator defines this test definition by the choices made using the graphical user interface.

That means that the test operator need no longer write test scripts, or even know what the test scripts say. Any test parameters that the test operator wants to specify can be chosen through the graphical user interface.

Each test script is structured as follows.
1. The test script provides the definition of trigger scripts.
2. The nodes are created and configured (protocol, IP address, port).
3. The protocol objects are created and configured (OpenRP Sessions, PPP Sessions, etc.).
4. The protocol objects are associated with nodes and/or other objects.
5. All desired triggers are set. Not all protocol layers will require a trigger to be set. Most will simply complete normally.
6. Initialize any global variables used by the triggers.
7. The test script should be written so that the simulation can be run by invoking the “start” procedure

An example of a TCL script can be seen in Appendix A.

Setting Up the Test Configuration

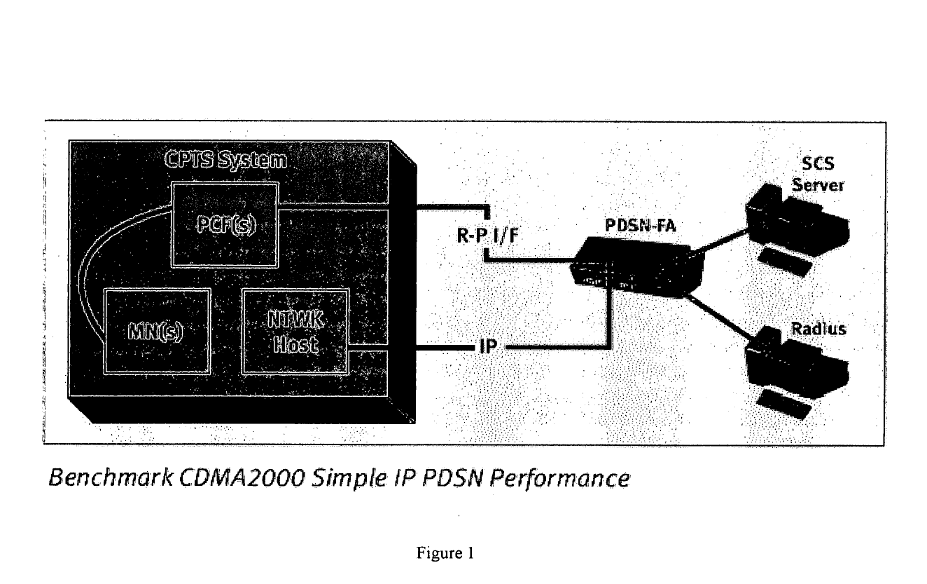

FIG. 1 shows a block diagram of the interactions of the CPTS for a benchmark CDMA2000 Simple IP PDSN performance test. The CPTS can be used to test FAs and HAs separately or in combination. In the example shown in FIG. 1, however, only an FA is being tested.

The test operator can choose to emulate a variety of network components. The CPTS supports the following emulators on each test server:
Mobile nodes—up to 200,000
PCFs—up to 1000 (1000 unique IP addresses)
FAs—up to3
HAs—up to 3
Secure gateways—up to 3
Network hosts—up to 3

The CPTS can be used to test the following access models.
Simple IP (SIP)
SIP Virtual Private Network (SIP VPN)
SIP Virtual Private Routed Network (SIP VPRN)
Mobility IP (MIP)
MIP VPN
MIP Reverse Tunnel
MIP Network Based VPN

The example shown in FIG. 1 models Simple IP access, which is the basic access model supported by a PDSN. In this context, the term Simple IP refers to the popular dial-up network access model. In this model, a PPP session is established between the mobile station and the PDSN. Then, the PDSN routes packets to/from the mobile to provide end-to-end IP connectivity between the mobile station and hosts on the Internet.

In this configuration, a single test server in the CPTS system will simulate the mobile nodes (MNs) and the PCFs, as well as a network host on the network side of the PDSN FA for testing with data traffic.

Running the Test

The CPTS is launched by invoking a TCL test script, which is done be simply pressing the start button on the GUI. The test script should be written so that the simulation can be run by invoking the “start” procedure.

Each node will require one or more IP addresses in order to communicate with the outside world. The node object will register its IP addresses with the simulation control function, and provide the event call-back function for arriving packets.

As described below, the protocol stacks are built in real time, when the test is being run. But the TCL scripts for the CPTS do not look like normal scripts. Rather than having a logical flow, the CPTS TCL scripts are simply a set of procedures that are invoked as events occur within the simulation environment.

A typical test tool script operates sequentially. A command is sent, and then the system waits for an event to occur, or for a certain amount of time to pass. During this waiting period, the system must be in some sort of polling mode to determine whether the event has occurred.

When the CPTS script operates, selected FSMs in the protocol stack have event triggers and timers. So the script need not operate sequentially, but instead can merely set up the protocol stack and let it run. If an event activates a trigger, the control can take over (e.g. timer expiration, call established, stop event, . . . ).

Dynamically Linking the Protocol Stacks

To simulate a user, a load generator must build the appropriate protocol stack. The more efficiently this can be done, the more users can be simulated. At the same time, to perform a “real-world” simulation, the right protocol stacks must be generated, in the right numbers. Speed in generating large numbers of protocol stacks is important, however more important is the ablility to create and manage large number of stacks (i.e. hundreds of thousands).

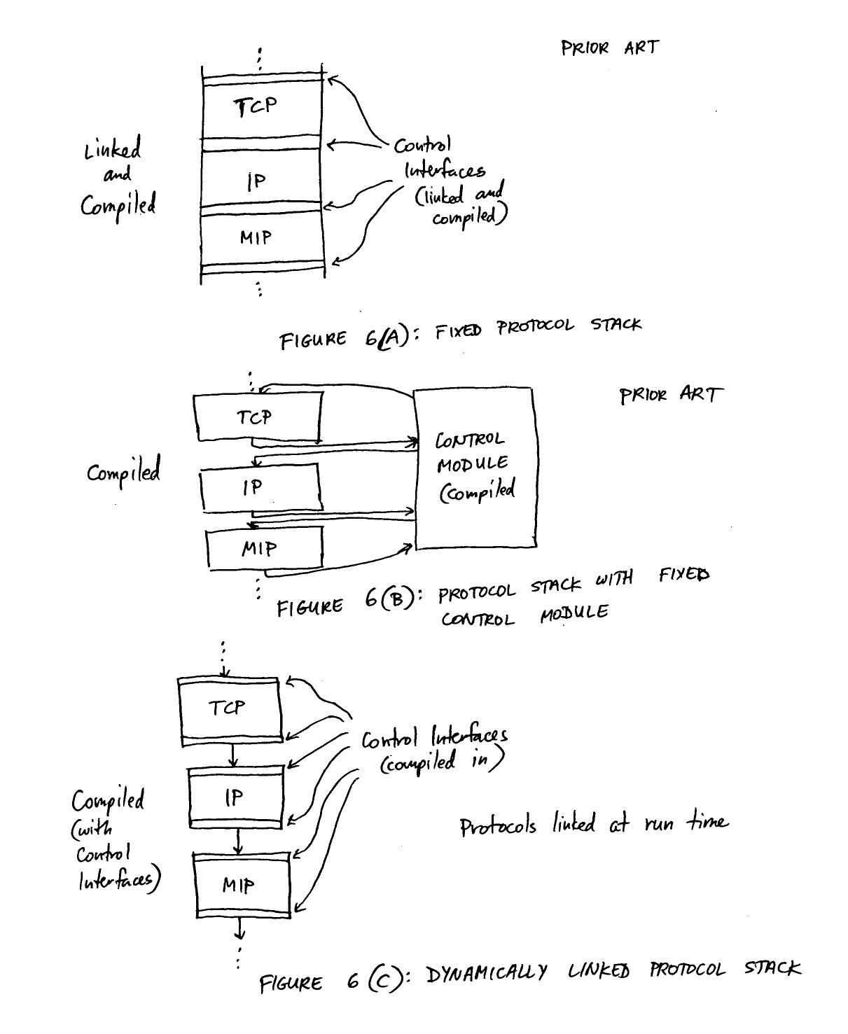

Test tools currently use several methods to generate protocol stacks. Two methods are described here, as shown in FIGS. 6(A) and 6(B). Existing test tools may use either, or a combination of both, to generate protocol stacks.

Most existing test tools use special hardware that is locked into generating protocol stacks in a particular way. To change the protocol, the hardware must be modified. The high capacity of this invention needs no particular hardware. Software changes can be easily made by changing the TCL script, so that no code needs to be recompiled.

First, the “hard coding” method. With this method, each protocol stack is put together by stack-building code written in C++, or a similar language. The stack is then compiled as a whole. In this case, the code runs quickly, since it has been compiled into object code.

On the other hand, if any change needs to be made, the code must be recompiled. Speed of operation is good. But flexibility is very limited.

Second, the “control” method. With this method, each protocol stack is put together in real time. The elements of the stack are compiled separately with an interface to a control system on each end.

During the building of each protocol stack, the control system must control each element. In addition, the control system is typically written in an interpreted language such as TCL, and all events which are required to be passed between the layers are managed by the control function.

This method brings more flexibility than the hard coding method. But it also gives up speed of operation. And the control system, by needing to control the building of every element of every stack, uses lots of processor time.

By contrast, the high-capacity test tool of this invention uses the “dynamic linking” method, as shown in FIG. 6(C). Each element of the protocol stack, written in C++ or a similar language, contains some interface code on each end. The building of the stack can then be controlled by a script written in an interpretive language, like TCL, rather than a compiled language.

Unlike the “control” method, though, with the dynamic linking method, the control system need only be minimally involved in the execution of the stack. Normal events between the protocol layers are propagated via the configured links (via object code compiled from C++). That saves processor time. Moreover, the elements of the stack operate as quickly as the “hard coding” method, since they have been compiled into object code. That speeds up operation.

The difference can be dramatic. In terms of scalability, the dynamic linking method can simulate many more users with the same amount of memory and processor time. In terms of flexibility, the method can be modified very easily.

Reporting Results

The reporting system of the CPTS provides a real-time event log throughout the execution of a test session. In addition, detailed interim and final reports are provided for each test case. The reports include all of the test measurement data, as well as operational measurements for each protocol layer.

Script triggers create log files with test results. For test sessions involving multiple test cases, separate reports are provided for each test case, with a summary report detailing the combined results for the test session.

In addition to test reports and protocol measurements, each emulator provides detailed measurements based on its function. For example, the PDSN FA emulator provides a complete set of operational statistics for its interface to the HA under test.

### SECOND EXAMPLE

### Test Tool for Load Testing a Website

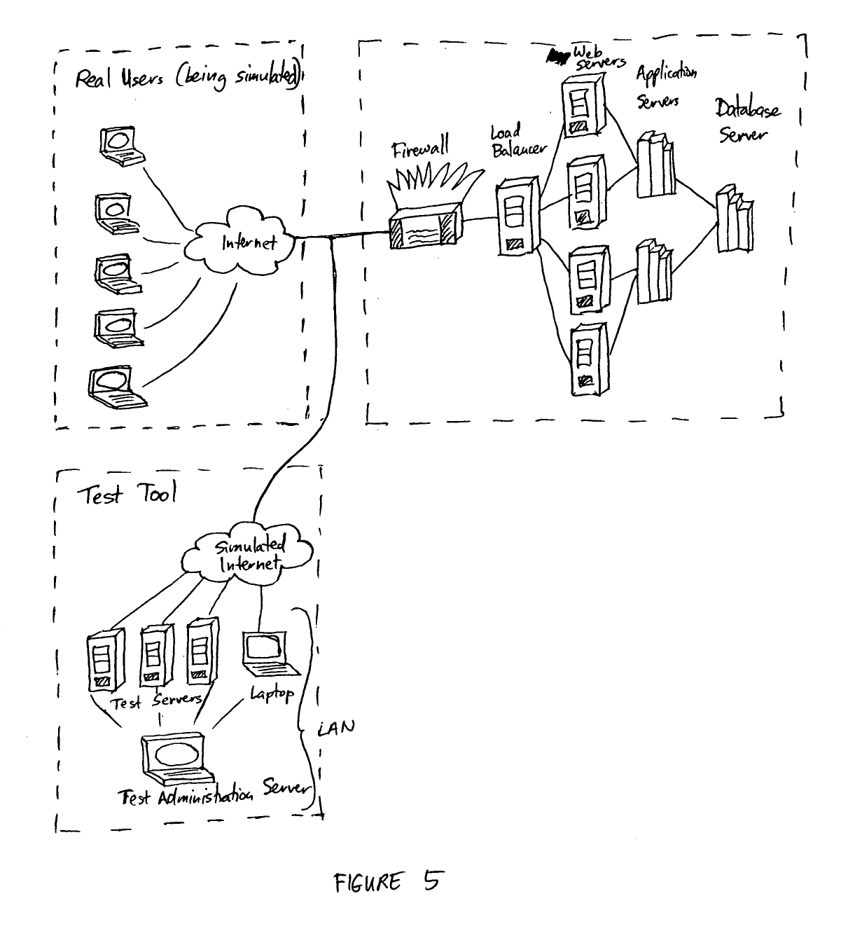

Another example of a test tool of this invention can be seen in FIG. 5. Here the system under test is a Website consisting of a firewall, load balancer, four Web servers, two application servers, and a database server.

In this example, the test tool of this invention carries out the same steps as described above for the CPTS example. Here the protocol stack is simpler, as shown below:

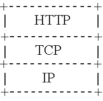

A finite state machine must be generated for each of the protocals to be used in the test. Then those protocols are dynamically linked at run time to form the protocol stacks. As with the CPTS example, the throughput that can be achieved by using a test tool of this invention will exceed that of existing test tools.

### OTHER EXAMPLES

Other examples of a test tool of this invention include the following:
A test tool for networks that can generate protocol stacks fast enough to simulate at least 100,000 simultaneous sessions per test server, and to start at least 500 new sessions per second per test server. This tool may be able to dynamically link at least two protocols into a protocol stack at run time, and may be able to test data networks. It may be able to run on commercially available servers and an open source operating system.
A test tool for networks where two or more finite state machines are used to represent layers in a protocol stack, and two or more of the finite state machines can be dynamically linked at run time into a protocol stack. This test tool may have at least one of the finite state machines that can be compiled before run time. It may also have at least one of the finite state machines that can have an event trigger incorporated into it before it is compiled.
A method for testing networks that includes the steps of using at least two finite state machines to represent layers in a protocol stack, incorporating an event trigger into at least one finite state machine, and dynamically linking at least two finite state machines into a protocol stack at run time. This method may also include the step of compiling at least one of the finite state machines before run time.

### CONCLUSION

The test tool of this invention provides many advantages over existing test tools. These include the ability to:
scale to millions of users
generate thousands of new calls per second
realistically simulate real-world traffic
run on standard servers (not custom equipment) on open operating systems
perform both control and data traffic testing
perform all kinds of testing: capacity, performance, traffic, and soak
be easily updated or modified
be cost-effective

We claim:

1. A test tool for networks that can generate protocol stacks fast enough to simulate at least 100,000 simultaneous sessions per test server, and to start at least 500 new sessions per second per test server.

2. The test tool of claim 1 that can dynamically link at least two protocols into a protocol stack at run time.

3. The test tool of claim 1 that can test data networks.

4. The test tool of claim 1 that can run on commercially available servers and an open source operating system.

5. A test tool for networks where
two or more finite state machines are used to represent layers in a protocol stack, and
two or more of the finite state machines can be dynamically linked at run time into a protocol stack.

6. The test tool of claim 5 where at least one of the finite state machines can be compiled before run time.

7. The test tool of claim 5 where at least one of the finite state machines can have an event trigger incorporated into it before it is compiled.

8. A method for testing networks including the steps of:
using at least two finite state machines to represent layers in a protocol stack,
incorporating an event trigger into at least one finite state machine, and
dynamically linking at least two finite state machines into a protocol stack at run time.

9. The method of claim 6 including the step of compiling at least one of the finite state machines before run time.
